(19) United States
(12) Patent Application Publication
(10) Pub. No.: US 2011/0276950 A1
(43) Pub. Date: Nov. 10, 2011

(54) NAME BINDING EXTENSIBILITY FOR TYPED PROGRAMMING LANGUAGE

(75) Inventors: Jomo A. Fisher, Redmond, WA (US); Donald Syme, Grantchester (GB); Lucas J. Hoban, Seattle, WA (US); Timothy Yat Tim Ng, Bellevue, WA (US)

(73) Assignee: Microsoft Corporation, Redmond, WA (US)

(21) Appl. No.: 12/773,855

(22) Filed: May 5, 2010

(51) Int. Cl. G06F 9/45

(52) U.S. Cl. 717/140

(57) ABSTRACT

Architecture that provides a way to plug into a compiler (e.g., F#) and the associated language service. The language components define a standard plug-in mechanism that allows any component to plug into the services and, provide name binding and type resolution services. The compiler and language service utilize the protocol defined (e.g., in the shape of interfaces and classes that must be implemented in order to plug-in to the system) to provide compile time and design time extensions. The architecture provides the ability to define a customized protocol to interact with the compiler's name binding mechanism. The use of this protocol allows not only compilation to succeed, but to also provide rich IDE services, such as name lookup, and value lookup for quick information. Additionally, the capability to provide static type information to satisfy the requirements of a typed programming language is supported.

### BACKGROUND

A characteristic of many statically typed languages is the tension between providing static type safety and the dynamic nature of data. Many attempts have been made to solve this issue, where code generators (both design time and runtime) are the most commonplace. However, code generators have a unique problem of requiring an external tool to run to update the artifacts in order for the user's integrated development environment (IDE) experience to be “current”. The general problem is that many of the compilers and language definitions today do not allow customization of the internal compiler pipeline, which forces code generation as a work-around.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a way to plug into a compiler (e.g., F#) and the associated language service. The language components define a standard plug-in mechanism that allows any component to plug into the services and, provide name binding and type resolution services. The compiler and language service utilizes the protocol defined (e.g., in the shape of interfaces and classes that must be implemented in order to plug-in to the system) to provide compile time and design time extensions.

The architecture provides the ability to define a customized protocol to interact with the compiler's name binding mechanism. The use of this protocol allows not only compilation to succeed, but to also provide rich IDE services, such as name lookup, and value lookup for quick information. Additionally, the capability to provide static type information to satisfy the requirements of a typed programming language is supported.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system for interfacing with an internal compilation pipeline in accordance with the disclosed architecture.

FIG. 2 illustrates a computer-implemented method of interacting with an internal compilation pipeline in accordance with the disclosed architecture.

FIG. 3 illustrates further aspects of the method of FIG. 2.

FIG. 4 illustrates an alternative method of interacting with an internal compilation pipeline.

FIG. 5 illustrates further aspects of the method of FIG. 4.

FIG. 6 illustrates a block diagram of a computing system that executes an extensible interface for interacting with types of a compilation pipeline in accordance with the disclosed architecture.

### DETAILED DESCRIPTION

Generally, compilers (compilation components) have three different phases (or processes) in the compilation pipeline: syntax analysis (which includes sanning and parsing) and semantic analysis (which includes program verification, type checking, etc., and code generation. The scanning and parsing phases can be referred to as frontend processes and the code generation can be referred to as a backend process. The frontend determines the syntactic structure of a program and translates the structure into an in-memory syntax tree. The frontend then performs a semantic analysis phase that converts a syntax tree into an annotated semantic tree, and converts the annotated semantic tree into an executable program (e.g., .exe file, .dll file, etc.). The code generator can be tightly coupled to the target program (e.g., .NET framework, word processor, spreadsheet, etc.).

The scanner tokenizes incoming text of the programming language for input to the parser, and eliminates undefined grammar such as comments. The parser ensures conformity of the source program to the language definition, handles error processing, creates the in-memory representation of program syntax for consumption by the code generator, and determines the runtime types to use.

In the disclosed architecture, an extensible interface (plug-in) is provided that allows the user to access one or more pipeline services, such as during semantic analysis to perform name binding. In a first phase of the process, pseudo types are inserted. The compiler receives the generated pseudo type from the extensions employed by the extensible interface. The generated pseudo type then flows through the type checking process like any other type (e.g., from concrete sources such as assemblies or user code) would flow through the compiler. Since pseudo types are not real types, the architecture cleans up process remnants left over from the pseudo type processing. For example, calls and the instances that were left in the program that is being generated are eliminated.

Another part of the extensible interface is to call back into the compiler and determine which pseudo types that ended up in the compiler via the extension should be turned into real types. Additionally, a request is made for pseudo methods or other code that is to be replaced by the real methods and code that were created by the extension. These replacements are then plugged in at the appropriate phase (compilation point) in the compilation process and the compiler then finishes by generating the program. In other words, generally, the extensible protocol is to introduce the pseudo type(s) via the extensibility interface, let the compiler do its work, and then eliminate the residue left by the pseudo type(s) in the compiler structures.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

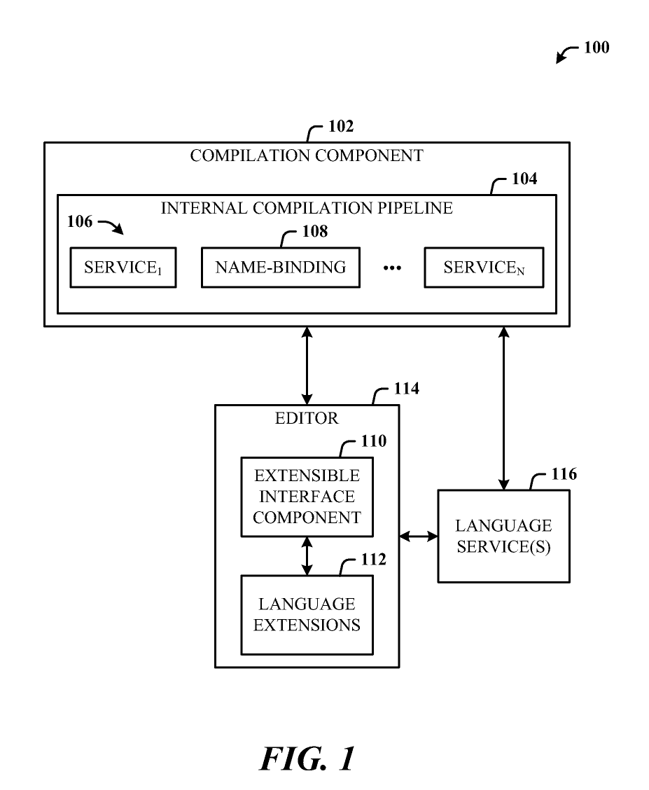

FIG. 1 illustrates a system 100 for interfacing with an internal compilation pipeline in accordance with the disclosed architecture. The system 100 includes a compilation component 102 of a typed programming language having an internal compilation pipeline 104 of services 106 that include a name binding service 108, and an extensible interface component 110 that facilitates access to the name binding service 108 via language extensions 112 to interact with types at compile time.

The interface component 110 and extensions 112 can be employed as a plug-in to an editor 114 as part of an integrated development environment (IDE). The editor 114 is designed for editing source code of computer programs and the like. The editor 114 can be a standalone program or built into the IDE. The system 100 can also employ language services 116. The editor 114 typically includes features designed to simplify and speed up input of source code. These features include, but are not limited to, syntax highlighting, auto-completion, bracket matching, parameter help, function list, tooltips, etc. The editor 114 can also perform syntax checking while the programmer types, immediately detecting and notifying the user of syntax problems.

The editor 114, backed by the language service(s) 116, can also act as a lookup tool. For example, in some known editors, a programmer can type a function name and in response to entering “,” (comma), a list of parameters are displayed for the function. It is to be appreciated, however, that this feature is offered by a language service, which works closely with the compiler to provide this information. This feature, available for members, parameters, functions and other program elements, is typically only available for statically typed program elements. In accordance with aspects of the disclosed architecture, this lookup feature is also available for information stored in the external data sources.

The extensible interface component 110 enables static binding of a pseudo type in the compilation pipeline 104. The extensible interface component 110 also enables replacement of the pseudo type with a real type at point(s) in the compilation runtime. The point(s) can be made accessible via the interface component 110, which can be published and made publicly visible so that users can plug into the extension point to extend the compiler in a controlled way. The compiler extensions can be integrated throughout the entire pipeline and also can influence the runtime behavior of an application executable that is generated by the extended compilation component 102.

An external data source can be a static or dynamic data source of any type. For example, an external data source can be a spreadsheet file containing data pertaining to a specific domain, an XML file containing data pertaining to a specific domain, an instance of a SQL database, a web service, or any dynamic or static external file. The extension point provides information to the compilation component 102. The information is extracted by reading these external data sources. The compilation component 102 and language service(s) 116 receive the information provided by the extension point, and from this information, the compilation component 102 and language service(s) 116 can provide the user a rich IDE experience that is equivalent to that received when programming against static types. The compilation component 102 can be any statically typed compiler, including but not limited, to an F# and/or C# compiler.

The extensible interface component 110 also enables elimination of pseudo type remnants at runtime, where the remnants were created during type checking, for example, of the pseudo type. The extensible interface component 110 further exposes the language services 116 to compile time extensions and design time extensions. The compilation component 102 operates unimpeded in cooperation with the extensible interface component 110. The extensible interface component 110 also enables name lookup via the language extensions 112, and value lookup via the language extensions 112. The language extensions 112 also provide static type information suitable for the typed programming language.

More specifically, a protocol associated with the extensible interface component 102 is defined which allows for a plug-in (the extensible interface component 110) to abstract a value and a type. The plug-in then is utilized to implement a resolver method, which is able to resolve the types and values for the compiler (compilation component 102) during the name binding phase. The types and values are returned to the compiler, and the compiler then maps the types and values to internal compiler data structures, thereby allowing the rest of the compilation phases to proceed as normal. The protocol also allows for partial name lookup by the user to provide a full-fidelity IDE experience.

The protocol defines a method on the plug-in to invoke a particular method, property, or obtain a value. The compiler, when the user has embedded code that resolves through a host, emits code that calls to the plug-in runtime helper to retrieve a particular value via a property, method, or value. The plug-in is responsible for implementing this, and resolves the value. For example, a spreadsheet related plug-in resolve against the spreadsheet DOM (document object model); an XML (extensible markup language) related plug-in may resolve by reading and parsing XML, etc.

In other words, any third party can provide a plug-in to extend the compiler since the architecture disclosed herein is generic and allows implementations of plug-ins against any domain specific data.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

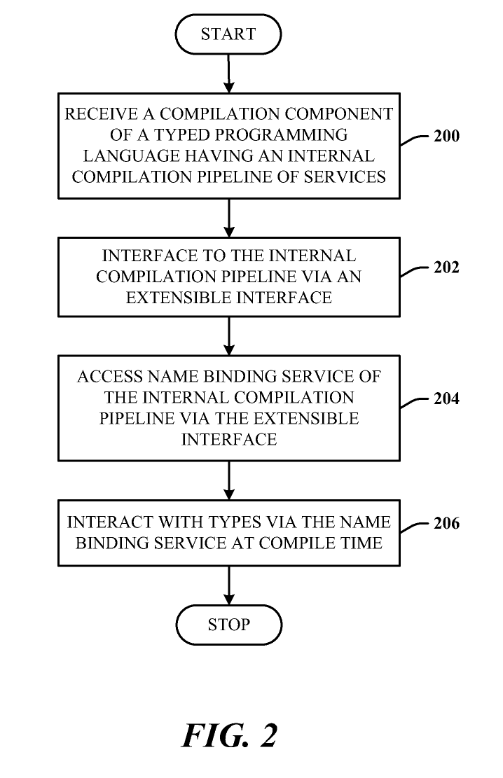

FIG. 2 illustrates a computer-implemented method of interacting with an internal compilation pipeline in accordance with the disclosed architecture. At 200, a compilation component of a typed programming language is received having an internal compilation pipeline of services. At 202, an interface to the internal compilation pipeline is provided via an extensible interface. At 204, a name binding service of the internal compilation pipeline is accessed via the extensible interface. At 206, types are interacted with via the name binding service at compile time.

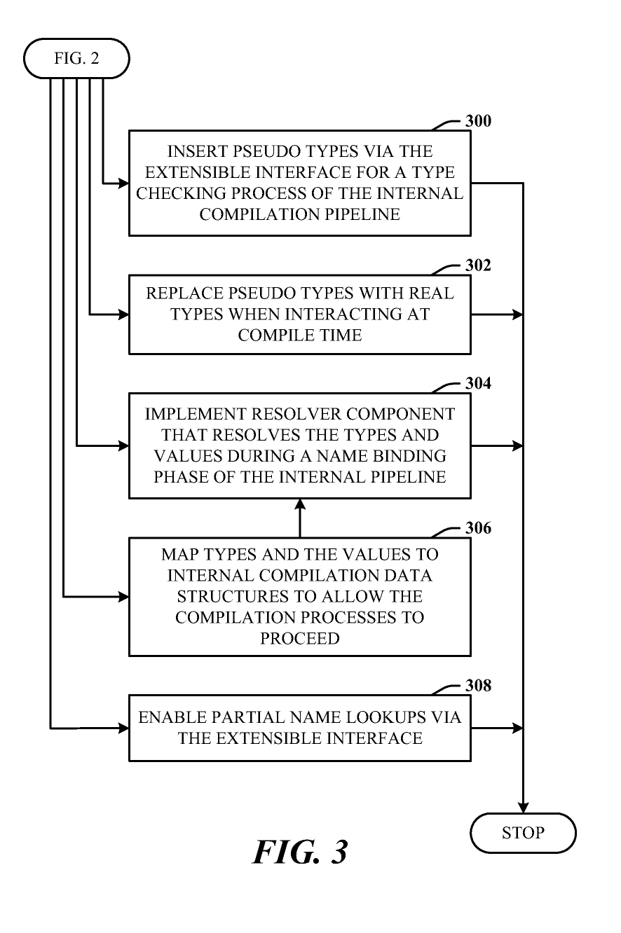

FIG. 3 illustrates further aspects of the method of FIG. 2. At 300, pseudo types are inserted via the extensible interface for a type checking process of the internal compilation pipeline. At 302, the pseudo types are replaced with real types when interacting at compile time. At 304, a resolver component is implemented that resolves the types and values during a name binding phase of the internal pipeline. At 306, the types and the values are mapped to internal compilation data structures to allow the compilation processes to proceed. At 308, partial name lookups are enabled via the extensible interface.

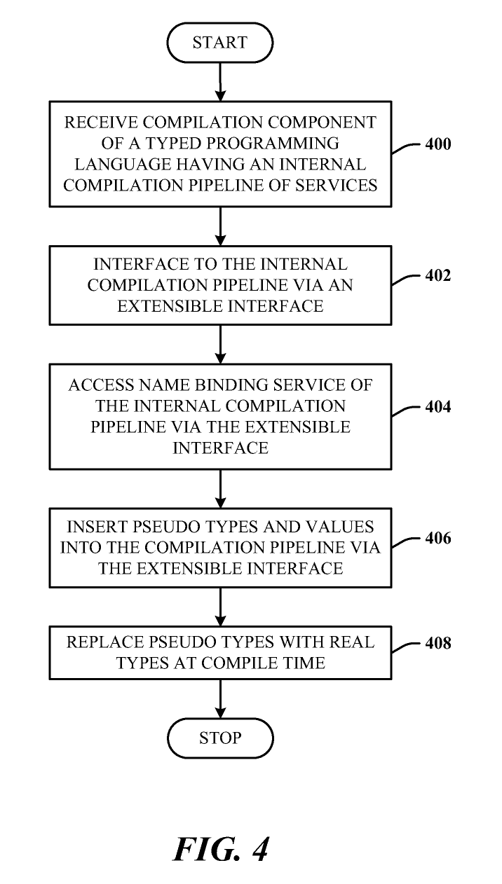

FIG. 4 illustrates an alternative method of interacting with an internal compilation pipeline. At 400, a compilation component of a typed programming language is received having an internal compilation pipeline of services. At 402, an interface to the internal compilation pipeline is provided via an extensible interface. At 404, a name binding service of the internal compilation pipeline is accessed via the extensible interface. At 406, pseudo types and values are inserted into the compilation pipeline via the extensible interface. At 408, the pseudo types are replaced with real types at compile time.

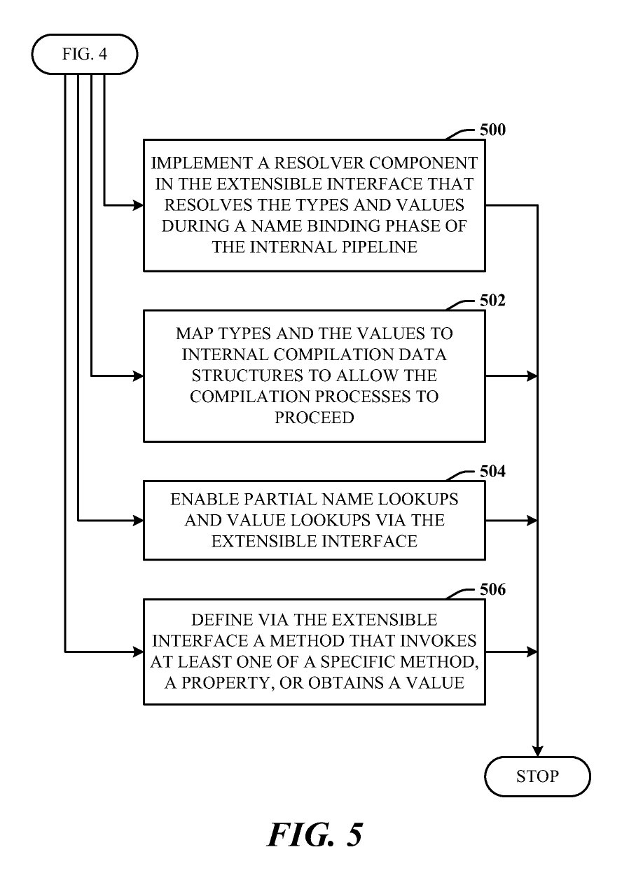

FIG. 5 illustrates further aspects of the method of FIG. 4. At 500, a resolver component is implemented in the extensible interface that resolves the types and values during a name binding phase of the internal pipeline. At 502, the types and the values are mapped to internal compilation data structures to allow the compilation processes to proceed. At 504, partial name lookups and value lookups are enabled via the extensible interface. At 506, a method that invokes at least one of a specific method, a property, or obtains a value is defined via the extensible interface.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

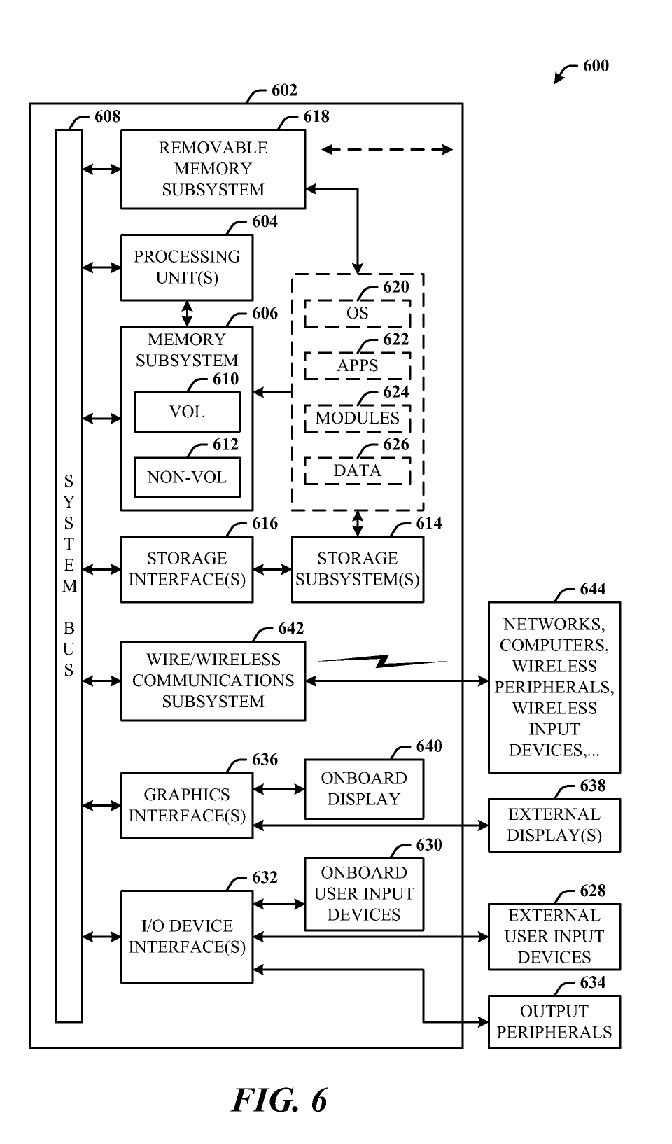

Referring now to FIG. 6, there is illustrated a block diagram of a computing system 600 that executes an extensible interface for interacting with types of a compilation pipeline in accordance with the disclosed architecture. In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include computer-readable storage (physical storage media) such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The one or more application programs 622, other program modules 624, and program data 626 can include the entities and components of the system 100 of FIG. 1, and the methods represented by the flowcharts of FIGS. 2-5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 602 and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system having computer readable media that store executable instructions executed by a processor, comprising:
a compilation component of a typed programming language having an internal compilation pipeline of services that include a name binding service; and
an extensible interface component that facilitates access to the name binding service via language extensions to interact with types at compile time.

2. The system of claim 1, wherein the extensible interface component enables static binding of a pseudo type in the compilation pipeline.

3. The system of claim 2, wherein the extensible interface component enables elimination of pseudo type remnants at runtime, the remnants created during type checking of the pseudo type.

4. The system of claim 3, wherein the extensible interface component enables replacement of the pseudo type with a real type at compilation runtime.

5. The system of claim 1, wherein the extensible interface component further exposes language services to compile time extensions and design time extensions.

6. The system of claim 1, wherein the compilation component operates unimpeded in cooperation with the extensible interface component.

7. The system of claim 1, wherein the extensible interface component enables name lookup via the language extensions.

8. The system of claim 1, wherein the extensible interface component enables value lookup via the language extensions.

9. The system of claim 1, wherein the language extensions provide static type information suitable for the typed programming language.

10. A computer-implemented method executed by a processor, comprising:
receiving a compilation component of a typed programming language having an internal compilation pipeline of services;
interfacing to the internal compilation pipeline via an extensible interface;
accessing a name binding service of the internal compilation pipeline via the extensible interface; and
interacting with types via the name binding service at compile time.

11. The method of claim 10, further comprising inserting pseudo types via the extensible interface for a type checking process of the internal compilation pipeline.

12. The method of claim 10, further comprising replacing the pseudo types with real types when interacting at compile time.

13. The method of claim 10, further comprising implementing a resolver component that resolves the types and values during a name binding phase of the internal pipeline.

14. The method of claim 13, further comprising mapping the types and the values to internal compilation data structures to allow the compilation processes to proceed.

15. The method of claim 10, further comprising enabling partial name lookups via the extensible interface.

16. A computer-implemented method executed by a processor, comprising:
receiving a compilation component of a typed programming language having an internal compilation pipeline of services;
interfacing to the internal compilation pipeline via an extensible interface;
accessing a name binding service of the internal compilation pipeline via the extensible interface;
inserting pseudo types and values into the compilation pipeline via the extensible interface; and
replacing the pseudo types with real types at compile time.

17. The method of claim 16, further comprising implementing a resolver component in the extensible interface that resolves the types and values during a name binding phase of the internal pipeline.

18. The method of claim 16, further comprising mapping the types and the values to internal compilation data structures to allow the compilation processes to proceed.

19. The method of claim 16, further comprising enabling partial name lookups and value lookups via the extensible interface.

20. The method of claim 16, further comprising defining via the extensible interface a method that invokes at least one of a specific method, a property, or obtains a value.
